(19) United States
(12) Patent Application Publication
(10) Pub. No.: US 2022/0366035 A1
(43) Pub. Date: Nov. 17, 2022

(54) EXECUTION CONTROL SYSTEM, EXECUTION CONTROL METHOD, AND PROGRAM

(71) Applicant: NEC Corporation, Minato-ku, Tokyo (JP)

(72) Inventors: Yoshiaki SAKAE, Tokyo (JP); Kazuhiko ISOYAMA, Tokyo (JP); Takashi KONASHI, Tokyo (JP); Jun NISHIOKA, Tokyo (JP)

(73) Assignee: NEC Corporation, Minato-ku, Tokyo (JP)

(21) Appl. No.: 17/619,314

(22) PCT Filed: Jun. 26, 2019
(86) PCT No.: PCT/JP2019/025414

§ 371 Date: Dec. 15, 2021

(51) Int. Cl. G06F 21/53

(52) U.S. Cl. CPC G06F 21/53; G06F 2221/033

(57) ABSTRACT

An execution control system (2000) determines whether to permit execution of a target application (30). The determination includes first determination and second determination. The second determination is performed when the first determination cannot determine whether to permit the execution of the target application (30). The execution control system (2000) executes the target application (30) in a protected environment after the first determination is finished and while the second determination is performed.

### TECHNICAL FIELD

The present invention relates to control of an operation of software.

### BACKGROUND ART

A system that controls an operation of software is developed. For example, PTL 1 discloses a technique that performs installation of software in a sandbox environment, and determines whether the installation of the software is desirable, based on an action generated during the installation performed in the sandbox environment.

### CITATION LIST

### Patent Literature

[PTL 1] Japanese Patent Application Publication No. 2017-021773

### SUMMARY OF INVENTION

### Technical Problem

The present inventor has found out a new technique for controlling an operation of software. The present invention has been made in view of the problem described above, and one object thereof is to provide a new technique for controlling an operation of software.

### Solution to Problem

An execution control system of the present invention includes a determination unit that determines whether to permit an operation of target software. The determination includes first determination and second determination, the second determination performed when the first determination cannot determine whether to permit an operation of the target software.

The execution control system of the present invention further includes a control unit that operates the target software in a protected environment after the first determination is finished and while the second determination is performed.

An execution control method of the present invention is executed by a computer. The execution control method includes a determination step of determining whether to permit an operation of target software. The determination includes first determination and second determination, the second determination performed when the first determination cannot determine whether to permit an operation of the target software.

The execution control method further includes a control step of operating the target software in a protected environment after the first determination is finished and while the second determination is performed.

A control method of the present invention is executed by a computer. The control method includes: 1) an acquisition step of acquiring, regarding an application for which processing of sensing an abnormality of the application is performed, introduction result information relating to introduction of the application; and 2) an evaluation step of performing evaluation of the application by use of the acquired introduction result information.

A program of the present invention causes a computer to execute each step of an execution control method of the present invention.

### Advantageous Effects of Invention

The present invention provides a new technique for controlling an operation of software.

### BRIEF DESCRIPTION OF DRAWINGS

The above-described object, other objects, features, and advantages effects will become more apparent from a preferred example embodiment described below and the following accompanying drawings.

FIG. 1 is a diagram illustrating an outline of an operation of an execution control system according to the present example embodiment.

FIG. 2 is a diagram illustrating a configuration of an execution control system according to an example embodiment 1.

FIG. 3 is a diagram illustrating a computer for achieving the execution control system.

FIG. 4 is a flowchart illustrating a flow of processing executed by the execution control system according to the example embodiment 1.

FIG. 5 is a first diagram illustrating an apparatus configuration of the execution control system.

FIG. 6 is a second diagram illustrating an apparatus configuration of the execution control system.

FIG. 7 is a diagram illustrating introduction result information in a table format.

FIG. 8 is a diagram illustrating introduction criterion information in a table format.

FIG. 9 is a diagram illustrating a configuration that manages introduction criterion information.

FIG. 10 is a block diagram illustrating a functional configuration of the execution control system including an output unit.

### EXAMPLE EMBODIMENT

Hereinafter, an example embodiment of the present invention is described by use of the drawings. Note that, a similar reference sign is assigned to a similar component in all the drawings, and description thereof is not repeated where appropriate. Further, unless otherwise specially described, each block represents, in each block diagram, not a configuration on a hardware basis but a configuration on a function basis.

### Outline

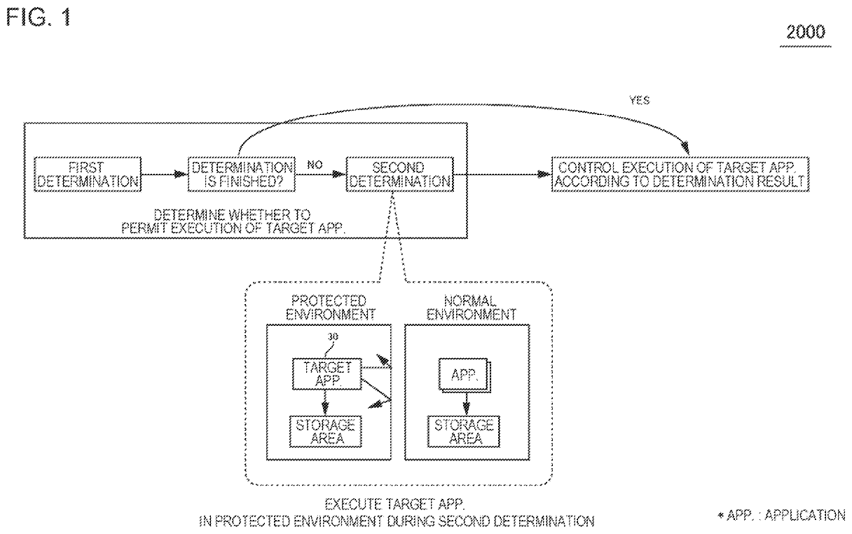

FIG. 1 is a diagram illustrating an outline of an operation of an execution control system 2000 according to the present example embodiment. FIG. 1 is a diagram representing conceptual description for easing understanding regarding an operation of the execution control system 2000, and does not specifically limit the operation of the execution control system 2000.

The execution control system 2000 performs determination of whether to permit an operation of software, and control of an operation of software. Hereinafter, in the present example embodiment, “execution of an application” is handled as an “operation of software”. “Loading of a shared library” being another example of an “operation of software” is described in a modification example described later.

Determination of whether to permit execution of an application, and control of execution of an application are performed. Herein, an application being targeted for determination by the execution control system 2000 is referred to as a target application 30. For example, an application activated by a user or another application is handled as the target application 30. Specifically, when a certain application is activated, the execution control system 2000 determines whether to permit execution of the application, before execution of the application is started. However, a timing of determining whether to permit execution of the target application 30 is not limited to a timing when the target application 30 is activated.

For example, determination of whether to permit execution is performed by determining whether the target application 30 is a normal application. Performing such determination can prevent damage from being caused by execution of an abnormal application (e.g., an application having a high probability of being malware).

Determination of whether to permit execution of the target application 30 by the execution control system 2000 includes a first determination and a second determination. The second determination is executed when the first determination cannot determine whether to permit execution of the target application 30.

In the execution control system 2000, the target application 30 can operate in at least two kinds of execution environments. The execution environments include a protected environment and a normal environment. An operation of the target application 30 executed in a protected environment is more restricted than when executed in a normal environment. As an example of a restriction, writing of data (writing into a storage area, transmission to outside, or the like) can be cited. When writing of data is restricted, the target application 30 executed in a protected environment is not allowed to write data, regarding, for example, at least a part of a storage area where the target application 30 executed in a normal environment can write data.

The execution control system 2000 does not execute the target application 30 until the first determination is completed. Then, when the first determination cannot determine whether to permit execution of the target application 30, and the second determination is performed, the execution control system 2000 operates a target application in a protected environment until determination of whether to permit execution of the target application 30 is finished.

### One Example of Advantageous Effect

It can be conceived that a user of the target application 30 desires to utilize the target application 30 earlier. Thus, it can be conceived to execute the target application 30 in a protected environment while whether to permit execution of the target application 30 is determined. This can prevent a target application from compromising another application or the like, while allowing a target application, which is not yet clear about whether the target application may be executed, to be executed early. Specifically, while requirement of a user desiring earlier execution start of an application is met, occurrence of a problem due to execution of the application can be prevented.

However, for example, for the following reason, it is difficult to say that execution in a protected environment is always the best regarding the target application 30 for which whether to permit execution is being determined. When execution is permitted regarding the target application 30 being executed in a protected environment, the target application 30 needs to be executed in a normal environment later. To do so, as described later, it is necessary to switch an execution environment of the target application 30 from a protected environment to a normal environment, or temporarily finish execution of the target application 30 and activate the target application 30 in a normal environment again. In contrast, when execution is permitted regarding the target application 30 being in a state where activation thereof is suspended, the suspended activation may be resumed. Thus, processing required after execution of the target application 30 is permitted becomes comparatively simple. Therefore, when processing after determination of whether to permit execution of the target application 30 is completed is considered, it can be conceived that temporarily suspending activation of the target application 30 is preferred to executing the target application 30 in a protected environment, as long as determination of whether to permit execution of the target application 30 is finished in a short time.

Accordingly, in the execution control system 2000, determination of whether to permit execution of the target application 30 includes a first determination and a second determination, and, when the first determination cannot determine whether to permit execution, and the second determination is needed, the target application 30 is executed in a protected environment. By doing so, while processing required after execution of the target application 30 is permitted is also considered, requirement of a user desiring earlier execution start of the target application 30 can be met, and occurrence of a problem due to execution of the target application 30 can be prevented.

Hereinafter, the execution control system 2000 according to the present example embodiment is described in further detail.

### Example of Functional Configuration of Execution Control System 2000

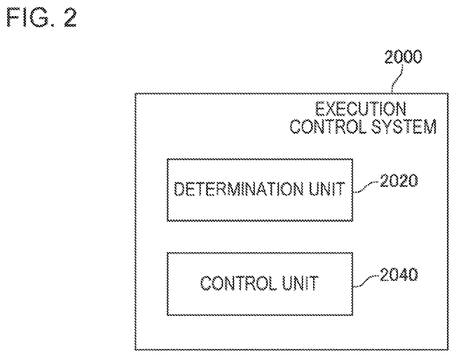

FIG. 2 is a diagram illustrating a configuration of the execution control system 2000 according to an example embodiment 1. The execution control system 2000 includes a determination unit 2020 and a control unit 2040. The determination unit 2020 determines whether to permit execution of the target application 30. Determination of whether to permit execution includes a first determination and a second determination. The control unit 2040 executes the target application 30 in a protected environment after the first determination is finished and while the second determination is performed.

### Hardware Configuration of Execution Control System 2000

Each functional configuration unit of the execution control system 2000 may be achieved by hardware (ex: a hard-wired electronic circuit, or the like) that achieves each functional configuration unit, or may be achieved by a combination of hardware and software (ex: a combination of an electronic circuit and a program controlling the electronic circuit, or the like). A case where each functional configuration unit of the execution control system 2000 is achieved by a combination of hardware and software is further described below.

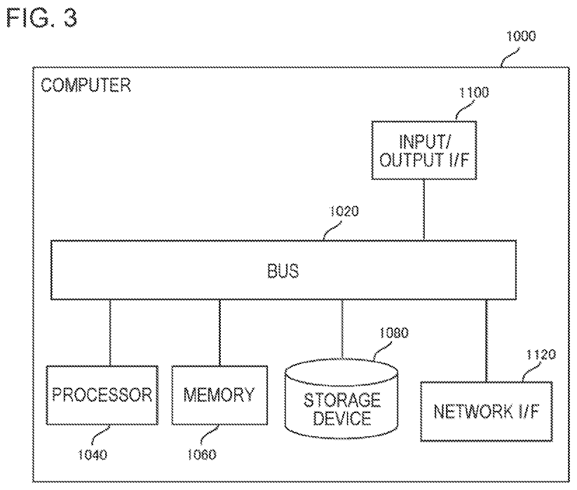

For example, the execution control system 2000 is achieved by one computer. FIG. 3 is a diagram illustrating a computer 1000 for achieving the execution control system 2000. The computer 1000 is any computer. For example, the computer 1000 is a personal computer (PC), a server machine, a tablet terminal, a smartphone, or the like. The computer 1000 may be a dedicated computer designed to achieve the execution control system 2000, or may be a general-purpose computer.

The computer 1000 includes a bus 1020, a processor 1040, a memory 1060, a storage device 1080, an input/output interface 1100, and a network interface 1120. The bus 1020 is a data transmission path through which the processor 1040, the memory 1060, the storage device 1080, the input/output interface 1100, and the network interface 1120 transmit/receive data to/from one another. However, a method of mutually connecting the processor 1040 and the like is not limited to bus connection. The processor 1040 is a processor such as a central processing unit (CPU), a graphics processing unit (GPU), or a field-programmable gate array (FPGA). The memory 1060 is a main storage apparatus achieved by use of a random access memory (RAM) or the like. The storage device 1080 is an auxiliary storage apparatus achieved by use of a hard disk drive, a solid state drive (SSD), a memory card, a read only memory (ROM), or the like. However, the storage device 1080 may be configured by hardware such as a RAM similar to hardware constituting a main storage apparatus.

The input/output interface 1100 is an interface for connecting the computer 1000 and an input/output device. The network interface 1120 is an interface for connecting the computer 1000 to a communication network. The communication network is, for example, a local area network (LAN) or a wide area network (WAN). A method of connecting the network interface 1120 to the communication network may be wireless connection or may be wired connection.

The storage device 1080 stores a program module that achieves a functional configuration unit of the execution control system 2000. The processor 1040 reads each of the program modules onto the memory 1060, executes the read program module, and thereby achieves a function being associated with each of the program modules.

The execution control system 2000 may be achieved by two or more computers. Each computer in this case also has, for example, a hardware configuration illustrated in FIG. 3.

### Flow of Processing

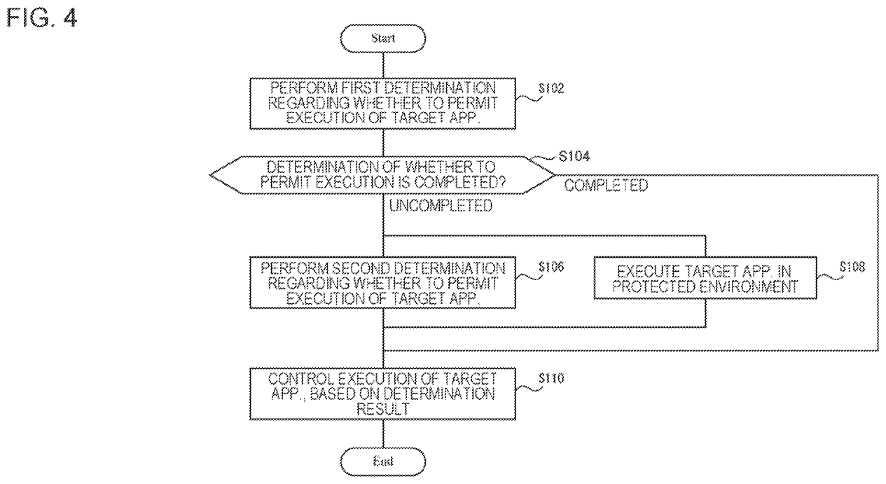

FIG. 4 is a flowchart illustrating a flow of processing executed by the execution control system 2000 according to the example embodiment 1. The determination unit 2020 performs first determination regarding whether to permit execution of the target application 30 (S102). When the first determination can determine whether to permit execution of the target application 30 (S104: completed), the control unit 2040 controls execution of the target application 30, based on a determination result (S110). On the other hand, when the first determination cannot determine whether to permit execution of the target application 30 (S104: uncompleted), the determination unit 2020 performs second determination regarding whether to permit execution of the target application 30 (S106). Moreover, while the second determination is performed, the control unit 2040 executes the target application 30 in a protected environment (S108).

When the second determination is completed, the control unit 2040 controls execution of the target application 30, based on a determination result (S110).

A timing when processing by the execution control system 2000 is started, for example, is a timing when a certain application is activated by a user or another application. The execution control system 2000 handles an activated application as the target application 30, and performs determination of whether to permit execution.

However, a timing when the execution control system 2000 determines whether to permit execution of an application may be before the application is activated. For example, when a new application is introduced into a first apparatus 10, the execution control system 2000 handles the application as the target application 30, and performs determination of whether to permit execution. In this case, when the target application 30 is activated, determination of whether to permit execution of the target application 30 may be already completed. Accordingly, for example, when determination of whether to permit execution is already completed regarding the target application 30 at activation of the target application 30, the execution control system 2000 controls execution of the target application 30, based on a result of the already completed determination. Moreover, when first determination is performed regarding the target application 30 at activation of the target application 30, the execution control system 2000 suspends activation of the target application 30 until the first determination is finished. Further, when second determination is performed regarding the target application 30 at activation of the target application 30, the execution control system 2000 executes the target application 30 in a protected environment.

In addition, for example, determination of whether to permit execution of the target application 30 may be performed at a regular timing (e.g., once a day). In this case, the execution control system 2000 performs, at a regular timing, determination of whether to permit execution regarding each application newly introduced into the first apparatus 10 (each application for which whether to permit execution is not performed yet). However, regarding the target application 30 activated before such a regular timing arrives, it is preferable to determine, at a timing of the activation, whether to permit execution of the target application 30.

### Specific Example of Apparatus Configuration of Execution Control System 2000

The execution control system 2000 is achievable by various apparatus configurations. Herein, some specific examples thereof are illustrated.

### Configuration Example 1

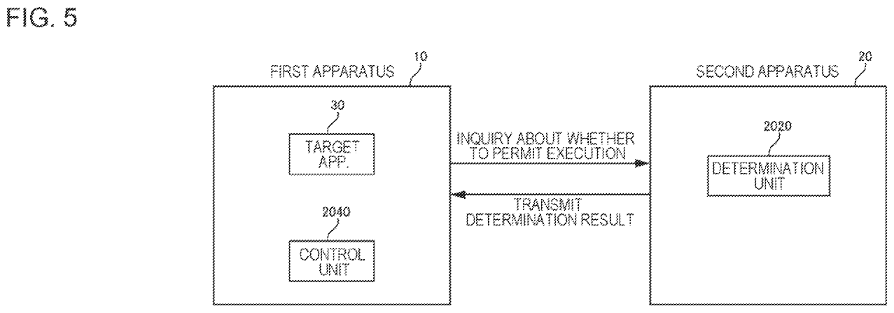

FIG. 5 is a first diagram illustrating an apparatus configuration of the execution control system 2000. In this example, the execution control system 2000 is constituted of the first apparatus 10 and a second apparatus 20. The first apparatus 10 is an apparatus that executes the target application 30. The second apparatus 20 is an apparatus that determines whether to permit execution of the target application 30.

The first apparatus 10 has a function of sensing whether an application is activated. When activation of an application is sensed in the first apparatus 10, the application is handled as the target application 30. The first apparatus 10 transmits, to the second apparatus 20, a request inquiring about whether to permit execution of the target application 30. The request includes identification information of the target application 30.

Moreover, the second apparatus 20 includes the control unit 2040. The control unit 2040 executes the target application 30 in a protected environment.

The second apparatus 20 is provided with the determination unit 2020. The determination unit 2020 receives the request described above from the first apparatus 10, and determines whether to permit execution, regarding the target application 30 determined by identification information indicated in the request. The determination unit 2020 transmits, to the first apparatus 10, a notification indicating a determination result of first determination. This notification indicates, for example, a combination of “identification information of the target application 30 and a determination result”.

When a determination result indicated by the notification described above is permission or non-permission, the control unit 2040 controls execution of the target application 30, based on the determination result. This finishes a series of processing by the execution control system 2000.

On the other hand, when a determination result indicated by the notification described above indicates that whether to permit execution cannot be determined (i.e., that second determination is performed), the control unit 2040 executes the target application 30 in a protected environment. Thereafter, the determination unit 2020 transmits, to the control unit 2040, a notification indicating a determination result of the second determination. The control unit 2040 controls execution of the target application 30, based on the determination result indicated by the notification.

### Configuration Example 2

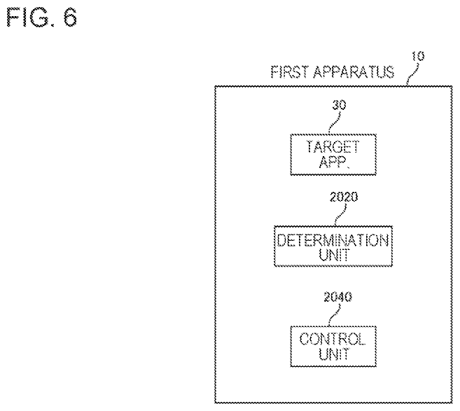

FIG. 6 is a second diagram illustrating an apparatus configuration of the execution control system 2000. In this example, both the determination unit 2020 and the control unit 2040 are provided within the first apparatus 10. Specifically, determination of whether to permit execution of the target application 30, and control of execution of the target application 30 are performed within an apparatus that executes the target application 30.

### Determination of Whether to Permit Execution: S102 and S106

The determination unit 2020 determines whether to permit execution of the target application 30 (S102 and S106). Determination of whether to permit execution of the target application 30 can be performed by utilizing any criterion. A specific criterion utilized for the determination of whether to permit execution of the target application 30 is described later.

Determination processing performed by the determination unit 2020 includes at least two stages of determinations being first determination and second determination. The second determination is executed when the first determination cannot determine whether to permit execution (when the first determination cannot complete the determination of whether to permit execution of the target application 30). Thus, a result of the first determination becomes any of results 1) permitting execution of the target application 30, 2) not permitting execution of the target application 30, and 3) advancing to the second determination.

Herein, another determination may be further performed before the first determination or after the second determination. Specifically, in the execution control system 2000, 1) determination by the determination unit 2020 includes a plurality of two or more stages of determination, 2) the target application 30 is not executed until specific determination (first determination) is completed, and 3) an advance is made to next determination (second determination), and the target application 30 is executed in a protected environment, when whether to enable execution cannot be determined even though the specific determination is completed. Note that, each stage of a determination result is any of results 1) permitting execution of the target application 30, 2) not permitting execution of the target application 30, and 3) advancing to next determination.

Note that, when another determination is performed later than the second determination, the target application 30 is executed in a protected environment during the another determination as well. Specifically, the target application 30 is executed in a protected environment after the second determination is started and until the determination of whether to permit execution of the target application 30 is completed.

Multiple stages of determination by the determination unit 2020 are configured, for example, in such a way that a time is required for determination as the stage advances. In other words, determination for which a required time is comparatively short is performed by priority (earlier), and, only when the determination of whether to permit execution of the target application 30 is difficult by such determination finishing in a short time, determination processing for which a required time is comparatively long is performed. This can shorten, as much as possible, a time required for the determination of whether to permit execution of the target application 30.

For example, each stage of determination by the determination unit 2020 is performed by use of a different criterion. For example, a configuration can be conceived in which, as a stage of determination rises, acquisition of information utilized for the determination requires time. Herein, information indicating a criterion used in first determination is referred to as first criterion information, and information indicating a criterion used in second determination is referred to as second criterion information. For example, a case can be conceived where the first criterion information is already stored in a storage apparatus, whereas the second criterion information is generated on the spot.

### Regarding Reuse of Determination

Regarding the target application 30 for which the determination of whether to permit execution is once performed, it is preferable to save a result of the determination, and eliminate a need for re-determination. To be specific, when the determination unit 2020 performs determination regarding whether to permit execution of the target application 30, a combination of “identification information of an application for which determination is performed, and a determination result” is stored in a predetermined storage apparatus. Hereinafter, information constituted by the above-described combination is referred to as determination result information. Moreover, a storage apparatus storing the determination result information is referred to as a determination result information storage apparatus.

When performing the determination of whether to permit execution of the target application 30, the determination unit 2020 first searches for information stored in the determination result information storage apparatus, by identification information of the target application 30. When determination result information indicating identification information of the target application 30 is stored, the determination unit 2020 utilizes a determination result indicated in the determination result information. On the other hand, when determination result information indicating identification information of the target application 30 is not stored, the determination unit 2020 performs the determination of whether to permit execution regarding the target application 30.

Herein, for such a reason that a criterion of determination of whether to permit execution is updated, a need to perform determination again can arise regarding the target application 30 for which the determination of whether to permit execution is performed once as well. Thus, when a criterion of the determination of whether to permit execution is updated, it is preferable that the determination unit 2020 does not utilize determination result information stored in the determination result information storage apparatus before the update. To do so, for example, when a criterion of the determination of whether to permit execution is updated, determination result information generated before the update is deleted from the determination result information storage apparatus.

### Execution in Protected Environment: S108

While second determination is performed, the control unit 2040 executes the target application 30 in a protected environment (S108). A protected environment referred to herein is an environment where at least a part of an operation of the target application 30 is more restricted as compared with a normal environment, and an operation of the target application 30 does not easily have an influence on another application. Such an environment can also be referred to as a sandbox environment.

Any restriction can be adopted as a restriction imposed on the target application 30 in a protected environment. For example, reading and writing of data, activation of a process, and the like by the target application 30 are restricted in a protected environment. For example, when writing of data is restricted, the target application 30 operating in a protected environment is controlled in such a way as to write data into a storage area that cannot be accessed from another application. For example, when the target application 30 makes a modification in data (a file stored in a storage device, a file mapped in a memory, a registry, data on a shared memory, or the like) shared with another application, a copy of the data is produced in a storage area that cannot be accessed from another application, in such a way that no modification is made in the copy. This allows another application not to recognize a modification of data performed by the target application 30. Thus, data written by the target application 30 can be prevented from having a negative influence on another application.

Note that, writing of the same data by the target application 30 operating in a protected environment and another application (that may be an application operating in a normal environment or may be an application operating in another protected environment) can also be conceived. In such a case, a conflict of writing needs to be resolved by some criterion. For example, the control unit 2040 gives priority to and applies (enables) writing at the latest writing point, and does not apply (disenables) other writing. In this case, in relation to an application to which writing is not applied, it is preferable to perform a notification that writing by the application is not applied.

Note that, it is assumed that the target application 30 operating in a protected environment and another application perform writing in parts of the same data that do not overlap each other. In this case, the control unit 2040 may apply writing of both the applications.

As another example of a resolution method of a conflict, the control unit 2040 may notify a user that there is a conflict in writing on data, at a timing when an operation environment of the target application 30 is shifted from a protected environment to a normal environment, and cause a user to select which application's writing to apply. In this case, the control unit 2040 applies writing by an application selected by a user, and does not apply writing by another application.

In addition, for example, the control unit 2040 may apply, by priority, writing by an application operating in a normal environment. In this case, when writing on data is performed by the target application 30 operating in a protected environment, the control unit 2040 produces a copy of the data, and applies writing to the copy. Then, at any timing (e.g., a timing when the target application 30 is shifted from a protected environment to a normal environment), the control unit 2040 notifies a user that writing is performed on a copy of data due to a conflict of writing, and notifies a user of a saving place of the copy, and the like.

In addition, for example, when the target application 30 operating in a protected environment performs writing on certain data, the control unit 2040 may then prohibit writing on the data by another application. In this case, it is preferable that the control unit 2040 notifies a user that writing is prohibited due to a conflict of writing.

When writing of data is restricted, for example, the target application 30 operating in a protected environment is restricted in read access to a specific storage area. In other words, a storage area that can be read-accessed is restricted. For example, a specific area is a storage area storing secret information, a system area utilized by an OS or middleware, or the like. This can prevent important data such as secret information from being stolen by a malicious target application 30, or prevent the first apparatus 10 from being compromised by the target application 30. However, as long as writing of data is restricted, outflow (writing) of data to outside by the malicious target application 30 can be prevented even when the target application 30 reads the data.

Note that, a restriction of reading and writing of data is not limited to a storage area. For example, reading and writing of data from and into a network (communication with an outside apparatus) may be restricted. This can prevent leakage of data via a network, and the like.

When activation of another application is restricted, the target application 30 operating in a protected environment is restricted in such a way that all or some applications cannot be activated. In a latter case, in other words, applications that can be activated are limited to some applications. Herein, some pieces of malware perform a malicious operation by utilizing another application (e.g., a shell). A malicious operation by such malware can be prevented by restricting activation of another application by the target application 30.

Moreover, when the target application 30 activates another application, the another application may also be executed in a protected environment. In this case, it is preferable that the target application 30 and the another application can share data with each other.

In addition, for example, an amount of a computer resource that can be utilized by the target application 30 may be restricted in a protected environment. As a computer resource, for example, a processor resource, a memory resource, a disk bandwidth, a network bandwidth, or the like can be cited. By executing the target application 30 in an environment where an amount of a computer resource that can be used is restricted in this way, for example, a negative influence on another application due to excessive use of a computer resource by the target application 30 can be prevented.

Herein, an existing method can be adopted regarding a specific method of achieving various kinds of control described above.

### Control When Execution is Permitted

When execution of the target application 30 is permitted by the determination unit 2020, the control unit 2040 changes an execution environment of the target application 30 to a normal environment. For example, it is assumed that reading and writing of data and activation of an application by the target application 30, an amount of a resource usable by the target application 30, or the like are more restricted in a protected environment than in a case of a normal environment. In this case, a restriction on the target application 30 is changed to a restriction similar to that in a normal environment.

Herein, when writing of data by the target application 30 is restricted in a protected environment, it is preferable that data written by the target application 30 when executed in a protected environment can be utilized even after the target application 30 is shifted to a normal environment. Thus, for example, the control unit 2040 moves or copies data written by the target application 30 in a protected environment to a storage area that can also be accessed from an application operating in a normal environment.

For example, it is assumed that the target application 30 being executed in a protected environment has made a modification in data shared with another application and therefore produces a copy of the data in a storage area that cannot be accessed from another application, and a modification is made in the data. In this case, the control unit 2040 reflects a content added to the copy, in original data as well.

### Control When Execution is Not Permitted

When execution of the target application 30 is not permitted by the determination unit 2020, the control unit 2040 finishes execution of the target application 30, for example. This can prevent the target application 30 whose execution is not preferred, such as an application having a possibility of being a threat to security, from being kept executed.

When finishing execution of the target application 30, the control unit 2040 may discard data written in a storage area by the target application 30 executed in a protected environment. Note that, the control unit 2040 may record data written by the target application 30, as information representing a record of an activity by the application 30. However, in this case, it is preferable to leave not only a final content in the storage area but also a record of writing of a series of data by the target application 30.

In addition, for example, the control unit 2040 may keep executing the target application 30 in a protected environment when execution of the target application 30 is not permitted by the determination unit 2020. This prevents the target application 30 from exerting a negative influence on another application or the like, and allows a user to continue execution of the target application 30.

### Regarding Criterion of Determining Whether to Permit Execution

The determination unit 2020 determines whether to permit execution of the target application 30, by various criteria. For example, a criterion related to introduction of the target application 30 can be utilized for determination of whether to permit execution of the target application 30. Description is given below in detail.

An application is introduced into an apparatus that executes the application. Introduction referred to herein refers to bringing the target application 30 into an executable state on an apparatus. For example, the target application 30 is introduced in the first apparatus 10.

When the target application 30 is acquired from outside of the first apparatus 10, introduction of the target application 30 into the first apparatus 10 also includes processing of acquiring the target application 30. Thus, for example, introduction of the target application 30 into the first apparatus 10 includes 1) processing of obtaining the target application 30, 2) processing of locating the obtained target application 30 on a file system, 3) processing of performing setting relating to the target application 30, and the like.

Obtaining of the target application 30 is, for example, processing of downloading the target application 30 from a server providing the target application 30, or reading the target application 30 from a storage apparatus storing the target application 30. Processing of locating the target application 30 on a file system is, for example, processing of storing an execution file or a setting file of the target application 30 in a predetermined directory. Processing of performing setting relating to the target application 30 is, for example, processing of writing, into, for example, a registry or a setting file, setting data necessary for execution of the target application 30.

Note that, processing of locating an execution file of the target application 30 in a predetermined directory or processing of performing setting relating to the target application 30 may be automatically performed by executing an installer of the target application 30, or may be manually performed by a user performing introduction work of the target application 30. Moreover, processing of obtaining the target application 30 can also be performed automatically. For example, there is a case where, when a certain application X needs another application Y, an installer of the application X automatically performs obtaining of the application Y.

When determining whether to permit execution of the target application 30 by a criterion relating to introduction of the target application 30, the determination unit 2020 acquires information related to introduction of the target application 30 into the first apparatus 10, and compares the information with a criterion relating to introduction of the target application 30. Hereinafter, information related to introduction of the target application 30 into the first apparatus 10 is referred to as introduction result information. Moreover, out of criterion information, criterion information utilized for determining whether to permit execution of the target application 30 by paying attention on introduction of the target application 30 into the first apparatus 10 is particularly referred to as introduction criterion information.

Introduction result information indicates information relating to introduction of the target application 30 in association with identification information of the target application 30. Identification information of the target application 30 is represented by, for example, a name of the target application 30, a path of an execution file of the target application 30, or the like. However, when a criterion of whether to enable execution of the target application 30 differs depending on an apparatus in which the target application 30 is introduced, a group of an apparatus, or the like, identification information of the target application 30 is represented by a combination of “identification information of the first apparatus 10 in which the target application 30 is introduced, a name of the target application 30, and the like”.

Various pieces of information can be adopted as information relating introduction of the target application 30 included in introduction result information. For example, introduction result information can include, for example, the following information.

1) Path information: information relating to an introduction path of the target application 30
2) Location information: information relating to a place where the target application 30 is located
3) Setting information: information relating to setting due to introduction of the target application 30

Regarding various pieces of information described above, a detailed content thereof and a method of acquiring the pieces of information are described below.

### Regarding 1) Path Information

Path information includes information relating to software, hardware, a service, and the like concerning introduction of the target application 30. Software concerning introduction of the target application 30 is, for example, a downloader utilized for downloading the target application 30, or an installer utilized for installation of the target application 30. Moreover, extraction software utilized for extraction of a compressed file when obtaining the file in which an installer and the like of the target application 30 are compressed can also be referred to as software concerning introduction of the target application 30. Hardware concerning introduction of the target application 30 is, for example, a storage apparatus or the like storing an installer, an execution file, and the like of the target application 30. A service concerning introduction of the target application 30 is, for example, a website providing an installer and the like of the target application 30, a proxy located between a provision source of the target application 30 and the first apparatus 10, or the like.

For example, it is assumed that a file F being a compressed file of an installer I of the application X is provided by a server S. Then, it is assumed that the application X is introduced into the first apparatus 10 by downloading the file F from the server S by use of a downloader D, extracting the file F by extraction software B, and executing the installer I of the application X acquired by the extraction. In this case, for example, path information regarding the application X indicates information “server S, downloader D, extraction software B, and installer I”.

Generation of path information can be achieved by, for example, utilizing a history of various events that can be related to introduction of the target application 30. An event is represented by, for example, a combination of “a subject, an object, and a content”. Events that can be related to introduction of the target application 30 are, for example, downloading of a file, extraction of a compressed file, execution of an installer, and the like. Herein, a history of the events is stored in a storage apparatus. Note that, an existing technique can be utilized for a technique for recording a history of the events. For example, a system call executed on the first apparatus 10 is recorded as an event.

Generation of path information is performed by, for example, agent software being resident in the first apparatus 10. For example, agent software senses occurrence of a specific event (hereinafter, a key event) that can occur due to introduction of the target application 30. For example, a key event is execution of an installer. Further, agent software determines, in response to sensing of a key event, another event related to the key event. For example, when a key event is execution of an installer, agent software extracts, from a history of events, an event being extraction of a compressed file including the installer, or an event being downloading of the compressed file.

By extraction of the event described above, an event sequence related to introduction of the target application 30 being “downloading of a compressed file including an installer->extraction of the compressed file->execution of the installer” can be extracted. Information about an introduction path can be generated from the event sequence. For example, determination of a provision source (a website or the like) of an installer of the target application 30, and determination of a downloader utilized for downloading can be performed based on a download event of a compressed file. Moreover, extraction software utilized for extraction can be determined based on an event being extraction of a compressed file including an installer. Further, an installer utilized for installation of the target application 30 can be determined based on an event being execution of an installer. Path information is constituted of the various pieces of determined information.

Note that, an event fulfilling a predetermined condition can be utilized for a key event. For example, a standard directory in which an application is located is previously determined for each OS or each piece of middleware, and it can be conceived that writing of a file into such a directory is an event having a high probability of being related to introduction of the target application 30. Thus, for example, agent software senses, as a key event, an event of writing a file into a standard directory in which an application should be located.

In addition, for example, introduction of an application frequently involves update of a registry or a predetermined setting file (a file storing an environment variable, or the like). Thus, for example, agent software senses, as a key event, an event of writing into a registry or a predetermined setting file.

In addition, for example, introduction of an application is frequently performed by utilizing a known installer (e.g., an installer prepared in an OS as standard). Thus, for example, agent software senses, as a key event, an event representing execution of such a known installer (an event representing execution of a predetermined program).

Note that, a predetermined condition used for detection of a key event is previously stored in a storage apparatus being accessible from agent software.

### Regarding 2) Location Information

Location information indicates information relating to a place (a directory or the like) where a file (an execution file, a setting file, or the like) related to the target application 30 is written.

For example, generation of location information is performed as follows. First, as a premise, a history of a writing event of a file is recorded. Then, the agent software described above generates location information by utilizing the history of the event. For example, the agent software first senses an event of execution of an installer. Further, the agent software determines a writing event of a file performed by the installer. Then, the agent software generates location information indicating a place where a file is written in each of the determined events.

### Regarding 3) Setting Information

Depending on the target application 30, a change is made in a registry or an existing setting file due to the installation of the target application 30. Setting information represents a change of setting made due to introduction of the target application 30 in this way.

For example, similarly to location information, setting information is generated by utilizing a history of a writing event of a file. For example, agent software first senses an event of execution of an installer. Further, the agent software determines a writing event into a registry or a predetermined setting file performed by the installer. Then, the agent software generates, for each of the determined events, setting information indicating a combination “identification information (a path or the like) of a file for which writing is performed in an event, and a content of data written into the file”.

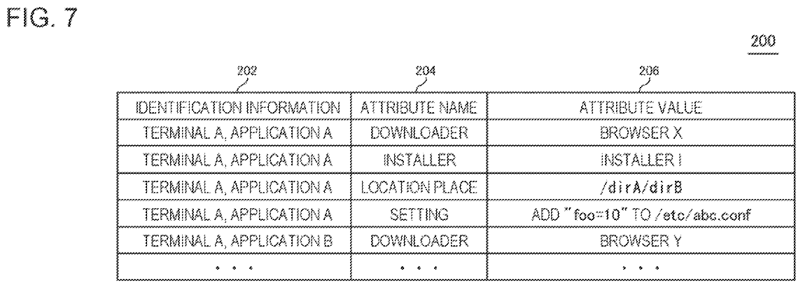

FIG. 7 is a diagram illustrating introduction result information in a table format. The table in FIG. 7 is referred to as a table 200. The table 200 includes two rows of identification information 202, an attribute name 204, and an attribute value 206. The identification information 202 represents identification information of the target application 30. The attribute name 204 represents a kind of information, such as a provision source, a downloader, extraction software, an installer, location information, and setting information. The attribute value 206 represents a content of information about a kind indicated by the attribute name 202. For example, a record indicating a set “identification information 202: an application A of a terminal X, attribute name 204: downloader, attribute value 206: a browser X” represents that the browser X is utilized as a downloader when the application A being executed in the terminal X is introduced.

Note that, generation of introduction result information does not necessarily need to be performed by the first apparatus 10, and may be performed by the second apparatus 20 or another apparatus. In this case, an apparatus that generates introduction result information generates introduction result information regarding each application introduced into the first apparatus 10, by use of a history of an event recorded regarding the first apparatus 10.

Herein, a timing when introduction result information is generated is a timing when introduction result information is utilized for determination by the determination unit 2020, or any timing before the utilization. In a latter case, for example, at a timing when a new application is introduced into the first apparatus 10, introduction result information regarding the application is generated.

The determination unit 2020 acquires introduction result information by any method. For example, when introduction result information is stored in a storage apparatus, the determination unit 2020 acquires introduction result information regarding the target application 30 from the storage apparatus. In addition, for example, the determination unit 2020 may acquire introduction result information by transmitting an acquisition request of introduction result information of the target application 30 to the agent software described above.

The determination unit 2020 acquires introduction result information regarding the target application 30, and introduction criterion information with which whether to permit execution of the target application 30 is determined by comparing the acquired introduction result information with the introduction criterion information. The introduction criterion information can also be referred to as a rule or a policy.

For example, introduction criterion information is information defining an introduction path and the like regarding a normal application. By utilizing such introduction criterion information, it can be determined that a normality degree of the target application 30 is high, for example, when a matching degree between introduction result information and the introduction criterion information is high. Such introduction criterion information is referred to as normal introduction criterion information.

For example, the following information is included in normal introduction criterion information.

1) Normal path information: a normal introduction path of the target application 30
2) Normal location information: a normal location place of the target application 30
3) Normal setting information: normal setting due to installation of the target application 30

Normal path information represents information about normal software, normal hardware, and a normal service related to introduction of the target application 30. For example, normal path information represents a normal service or hardware (a website, a storage apparatus, or the like) serving as a provision source of the target application 30. Further, for example, normal path information indicates normal software that can be utilized for introduction of an application, such as a normal installer, normal extraction software, and a normal downloader. Normal introduction criterion information is defined, for example, for each application. In addition, for example, normal introduction criterion information may be defined for each execution environment of an OS or the like.

Moreover, normal path information may represent a set of a normal provision source and software. For example, the information is information such as “a server S1, a downloader D1, and an installer I1”.

Normal location information indicates a normal place (a directory or the like) where an application should be installed. Note that, a place where an application should be located may be defined for each application or for each execution environment of an OS or the like.

Normal setting information represents normal setting performed due to introduction of an application. Normal setting information is defined, for example, for each application. For example, it is assumed that a predetermined record R is known to be added to a registry when the application X is introduced. In this case, normal setting information regarding the application X indicates “addition of the record R to the registry”.

Introduction criterion information may be information defining an introduction path and the like regarding an abnormal application. By utilizing such introduction criterion information, it can be determined that an abnormality degree of the target application 30 is high (a normality degree is low), for example, when a matching degree between introduction result information and the introduction criterion information is high. Such introduction criterion information is referred to as abnormal introduction criterion information.

For example, the following information can be included in abnormal introduction criterion information.

1) Abnormal path information: an abnormal introduction path of an application
2) Abnormal location information: an abnormal location place of an application
3) Abnormal setting information: abnormal setting due to installation of an application

Details of abnormal introduction criterion information can be recognized basically by replacing “normal” with “abnormal” in description of normal introduction criterion information. For example, while normal path information indicates normal software and the like that can be utilized for introduction of an application, abnormal path information indicates abnormal software and the like that can be utilized for introduction of an application. For example, when there is a known malicious website known to spread malware, a URL or the like of the website can be included in abnormal path information as a provision source of the abnormal software.

Herein, instead of dividing introduction criterion information into normality and abnormality, each attribute value may be indicated in association with a normality degree (or an abnormality degree) of the attribute value in introduction criterion information. For example, information such as “attribute name: installer, attribute value: installer I1, normality degree: c1” can be utilized as introduction criterion information.

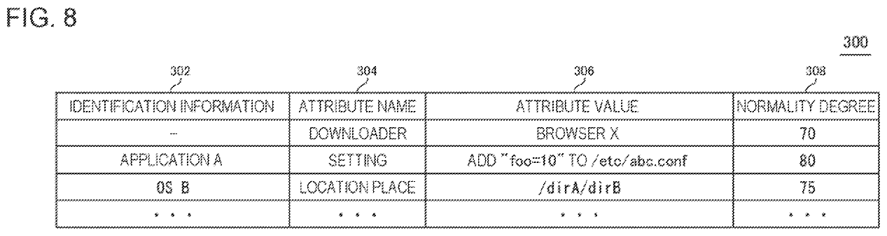

FIG. 8 is a diagram illustrating introduction criterion information in a table format. The table is referred to as a table 300. The table 300 includes four rows of identification information 302, an attribute name 304, an attribute value 306, and a normality degree 308. The identification information 302, the attribute name 304, and the attribute value 306 are similar to the identification information 202, the attribute name 204, and the attribute value 306 in the table 200. However, a record in which no data are indicated in the identification information 202 represents that the record does not depend on an application or an execution environment. The normality degree 308 represents a normality degree of an associated attribute value.

The determination unit 2020 determines whether to permit execution of the target application 30, by comparing introduction result information with introduction criterion information. For example, the determination unit 2020 computes an evaluation value representing a normality degree or an abnormality degree of the target application 30, by comparing introduction result information with introduction criterion information. In a case where an evaluation value represents a normality degree of the target application 30, the determination unit 2020, for example, permits execution of the target application 30 when the evaluation value is equal to or more than a predetermined threshold value, or does not permit execution of the target application 30 when the evaluation value is less than the predetermined threshold value. On the other hand, in a case where an evaluation value represents an abnormality degree of the target application 30, the determination unit 2020, for example, permits execution of the target application 30 when the evaluation value is equal to or less than a predetermined threshold value, or does not permit execution of the target application 30 when the evaluation value is more than the predetermined threshold value.

An evaluation value of the target application 30 is computed based on, for example, a matching degree between introduction result information and introduction criterion information. Herein, various existing techniques can be utilized for a technique itself for computing a matching degree between a rule or a policy (introduction criterion information in the present invention) and an actual situation (introduction result information in the present invention).

For example, a matching degree between introduction result information and introduction criterion information can be computed by use of an equation (1) below or the like.

$$\begin{matrix}[ Mathematical 1 ] & \\ v = \frac{\vert S \vert}{\vert E \vert} & ( 1 )\end{matrix}$$

Herein, v represents an evaluation value. E is a set of attribute values indicated in introduction result information, and |E| represents the number of elements of the set. Moreover, S is a set of attribute values matching each other between introduction result information and introduction criterion information, and |S| represents the number of elements of the set.

When introduction result information is compared with normal introduction criterion information, a matching degree thereof represents a normality degree of the target application 30. On the other hand, when introduction result information is compared with abnormal introduction criterion information, a matching degree thereof represents an abnormality degree of the target application 30.

Moreover, it is assumed that introduction criterion information indicates a normality degree of each attribute. In this case, an integration value or a statistical value (an average value, a median, a mode, a maximum value, a minimum value, and the like) of a normality degree of an attribute value matching between introduction result information and normal introduction criterion information can be utilized as an evaluation value representing a normality degree of the target application 30. For example, an evaluation value can be computed by use of an equation (2) below or the like.

$$\begin{matrix}[ Mathematical 2 ] & \\ v = \frac{{\sum }_{i ∈ S} {w}_{i}}{{\sum }_{j ∈ E} {w}_{j}} & ( 2 )\end{matrix}$$

Herein, wi is a normality degree given to an attribute value i.

On the other hand, it is assumed that introduction criterion information indicates an abnormality degree of each attribute. In this case, an integration value or a statistical value of an abnormality degree of an attribute value matching between introduction result information and normal introduction criterion information can be utilized as an evaluation value representing an abnormality degree of the target application 30. A computation method thereof is similar to that of an evaluation value representing a normality degree.

Note that, the determination unit 2020 may utilize, for evaluation, a degree of mismatch between introduction result information and introduction criterion information. For example, the determination unit 2020 computes an evaluation value representing a normality degree of the target application 30, by subtracting an evaluation value representing a mismatching degree between introduction result information and normal introduction criterion information, from an evaluation value representing a matching degree between introduction result information and normal introduction criterion information. Similarly, for example, the determination unit 2020 may compute an evaluation value representing an abnormality degree of the target application 30, by subtracting an evaluation value representing a mismatching degree between introduction result information and abnormal introduction criterion information, from an evaluation value representing a matching degree between introduction result information and abnormal introduction criterion information.

There are various methods of generating the introduction criterion information described above. For example, introduction criterion information is manually generated by an IT manager of an organization running the execution control system 2000, or the like. In addition, for example, introduction criterion information may be automatically generated by an apparatus. An apparatus that generates introduction criterion information may be the first apparatus 10, may be the second apparatus 20, or may be another apparatus. Hereinafter, an apparatus that generates introduction criterion information is referred to as a criterion information generation apparatus. A criterion information generation apparatus is a computer having a hardware configuration illustrated in FIG. 3, similarly to, for example, the first apparatus 10 or the second apparatus 20.

For example, a criterion information generation apparatus generates introduction criterion information, based on a record of introduction of the target application 30 in one or more of the first apparatuses 10 included in the execution control system 2000. Conceptually, an introduction path, a location place, and setting that are more frequently utilized in introduction of an application so far in each of one or more of the first apparatuses 10 are handled as an introduction path, a location place, and setting that are high in normality degree, respectively. For example, regarding each of the target applications 30, introduction result information is generated at a timing when the target application 30 is introduced, or the like. Then, the criterion information generation apparatus generates introduction criterion information by performing statistical processing for introduction result information generated so far.

For example, a normality degree of each attribute value is defined in such a way as to have a positive correlation with the number of pieces of introduction result information indicating the attribute value among pieces of introduction result information generated so far. For example, a normality degree is defined as a value acquired by inputting the number described above to a predetermined non-monotonic decreasing function. However, not the number of pieces of introduction result information but the number of the first apparatuses 10 may be counted. Specifically, a normality degree of an attribute value is defined in such a way as to have a positive correlation with the number of the first apparatuses 10 that have generated introduction result information indicating the attribute value.

When generating introduction criterion information indicating a normality degree, for example, a criterion information generation apparatus generates, regarding an attribute value for which a normality degree is computed by the method described above, introduction criterion information including a combination of the attribute value and the normality degree. When generating normal introduction criterion information, for example, a criterion information generation apparatus generates normal introduction criterion information including an attribute value of which a normality degree computed by the method described above is equal to or more than a predetermined threshold value. When generating abnormal introduction criterion information, for example, a criterion information generation apparatus generates normal introduction criterion information including an attribute value of which a normality degree computed by the method described above is equal to or less than a predetermined threshold value. Note that, a threshold value utilized for generation of abnormal introduction criterion information may be the same as or differ from a threshold value utilized for generation of normal introduction criterion.

Moreover, a criterion information generation apparatus may determine a normality degree or the like of each attribute value, based on a reputation in a group, an outside organization, or the like in which the execution control system 2000 is run. A reputation in a group in which the execution control system 2000 is run can be acquired by, for example, counting questionnaires conducted for a member of a group, or collecting information posted in a social networking service (SNS) run in a group. Moreover, a reputation in an outside organization can be collected by, for example, accessing a site publishing information relating to malicious software such as malware, a malicious website, and the like. By these methods, the criterion information generation apparatus collects information about the reputation, regarding various attribute values (a service or hardware serving as a provision source of an application, software utilized for introduction, a location place of an application, setting performed due to introduction of an application, and the like) that can be included in introduction criterion information. Then, the criterion information generation apparatus performs, based on the collected information about the reputation, processing of computing a normality degree or an abnormality degree of each attribute value, and processing of determining whether each attribute value is normal or abnormal. Then, the criterion information generation apparatus generates introduction criterion information, based on results of pieces of the processing.

Moreover, when the target application 30 is a well-known application with a high degree of reliability, information about an introduction path and a location place of the application, and setting performed due to introduction of the application may be published on a reliable website (e.g., a website being a provision source of the target application 30). Thus, the criterion information generation apparatus may generate introduction criterion information, by accessing a website or the like considered to provide information with a high degree of reliability regarding introduction of the target application 30, and acquiring the information.

There are various methods by which the determination unit 2020 acquires introduction criterion information. For example, the determination unit 2020 acquires introduction criterion information from a storage apparatus storing the introduction criterion information. In addition, for example, the determination unit 2020 may acquire introduction criterion information from a criterion information generation apparatus.

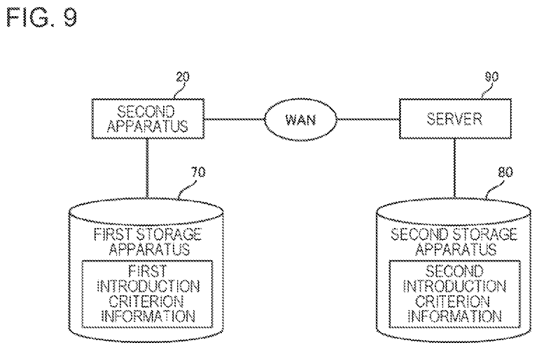

In addition, for example, the determination unit 2020 may acquire introduction criterion information by a method described below. FIG. 9 is a diagram illustrating a configuration that manages introduction criterion information. This example premises that the determination unit 2020 is provided in the second apparatus 20.

First, as storage apparatuses that can store introduction criterion information, a first storage apparatus 70 having a comparatively short time required for access from the determination unit 2020, and a second storage apparatus 80 having a comparatively long time required for access from the determination unit 2020 are provided. For example, the first storage apparatus 70 is a storage apparatus provided inside an apparatus in which the determination unit 2020 is provided, or a storage apparatus connected, by a LAN, to an apparatus in which the determination unit 2020 is provided. On the other hand, the second storage apparatus 80 is a storage apparatus (e.g., a cloud storage) connected, by a WAN, to an apparatus in which the determination unit 2020 is provided.

Introduction criterion information can be stored in both the first storage apparatus 70 and the second storage apparatus 80. Hereinafter, introduction criterion information being stored in the first storage apparatus 70 is referred to as first introduction criterion information, and introduction criterion information being stored in the second storage apparatus 80 is referred to as second introduction criterion information. The first introduction criterion information at start of running a criterion information generation apparatus is generated manually by, for example, an IT manager. Moreover, a criterion information generation apparatus may update the first introduction criterion information, based on a record of introduction of the target application 30 in the execution control system 2000. The second introduction criterion information is updated at any time by collection of information on the Internet by a server 90.

When acquiring introduction criterion information utilized for comparison with acquired introduction result information, the determination unit 2020 first accesses the first storage apparatus 70 and attempts acquisition of first introduction criterion information. When the first introduction criterion information includes an attribute value matching an attribute value indicated in the introduction result information, the determination unit 2020 utilizes the first introduction criterion information. On the other hand, when there is a matching attribute value that does not exist in the first introduction criterion information among attribute values indicated in the introduction result information, the determination unit 2020 accesses the server 90.

To be specific, the determination unit 2020 transmits a request indicating an attribute value to the server 90. The server 90 accesses the second storage apparatus 80, and determines whether the attribute value indicated in the request is included in second introduction criterion information. When the attribute value indicated in the request is included in the second introduction criterion information, the server 90 transmits, to the determination unit 2020, a response including a record of the second introduction criterion information indicating the attribute value. The determination unit 2020 utilizes information included in the received record, for determination of whether to permit execution of the target application 30. Moreover, the determination unit 2020 adds the record acquired in this way to the first introduction criterion information. By doing so, the same information can be acquired not from the second storage apparatus 80 but from the first storage apparatus 70 in and after next evaluation, and, therefore, acquisition of information can be performed earlier. On the other hand, when the attribute value indicated in the request is not included in the second introduction criterion information, the server 90 transmits, to the determination unit 2020, a response indicating that desired information is not included in the second introduction criterion information.

For example, it is assumed that determination utilizing only first introduction criterion information is first determination, and determination using second introduction criterion information as well is second determination. Specifically, when information is insufficient in first introduction criterion information, and acquisition of second introduction criterion information (access to the server 90) becomes necessary, determination by the determination unit 2020 advances from the first determination to the second determination. Thus, when acquiring second introduction criterion information, the second apparatus 20 transmits a notification “advance to the second determination” to the first apparatus 10.

Moreover, when whether to permit execution cannot be determined even by use of the second introduction criterion information, manual determination by an IT manager may be further added as third determination. For example, two threshold values T1 and T2 are provided regarding a domain of an evaluation value representing a normality degree (T1>T2). In this case, in the second determination, 1) execution of the target application 30 is permitted when an evaluation value is equal to or more than T1, 2) execution of the target application 30 is not permitted when an evaluation value is less than T2, or 3) the third determination is performed when an evaluation value is equal to or more than T2 and is less than T1.

When third determination is performed regarding the target application 30, for example, a terminal of an IT manager or the like (hereinafter, a manager terminal) is notified that the target application 30 needing the third determination is present. An IT manager or the like receiving this notification performs, for the manager terminal, input of selecting whether execution of the target application 30 is permitted. A result of this input is handled as a result of determination by the determination unit 2020.

A criterion other than a criterion relating to introduction of the target application 30 may be utilized for determination of whether to permit execution of the target application 30. For example, the following criteria can be utilized as other criteria.

1) An author of the target application 30
2) A signature of the target application 30 (a binary hash value or the like)
3) A reputation of the target application 30 itself

It can be conceived that, when an author of the target application 30 is a well-known person or organization, a normality degree of the target application 30 is high. Moreover, it can be conceived that, when a signature of the target application 30 matches a signature published regarding an application for which reliability is secured (e.g., which has been certified by a legitimate certificate authority), a normality degree of the target application 30 is high. Similarly, it can be conceived that, when a signature of the target application 30 introduced into the first apparatus 10 matches a signature of known malware, a normality degree of the target application 30 is low. Further, it can be conceived that, when a reputation of the target application 30 in a group, an outside organization, or the like running the execution control system 2000 (e.g., on the Internet) is high, a normality degree of the target application 30 is high.

Accordingly, various kinds of information that do not relate to introduction of the target application 30 can also become useful in performing determination of whether to permit execution of the target application 30. Thus, for example, the determination unit 2020 determines whether to permit execution of the target application 30, by further utilizing the various kinds of information. In this case, for example, criteria relating to an author, a signature, a reputation, and the like of the target application 30 are added to criterion information, in addition to the introduction criterion information described above. For example, the criteria are such criteria as “attribute name: author, attribute value: xyz.inc”. Moreover, the determination unit 2020 also acquires, regarding the target application 30, information relating to an author, a signature, a reputation, and the like of the target application 30, in addition to introduction result information. Then, the determination unit 2020 determines whether to permit execution of the target application 30, by comparing the acquired various kinds of information with the criterion information.

Herein, a method of comparing information relating to an author, a signature, a reputation, and the like acquired regarding the target application 30, with the pieces of information included in the criterion information is similar to a method of comparing introduction result information with criterion information. For example, the determination unit 2020 includes, in a computation equation of an evaluation value indicated in the equation (1) or (2) described above, not only a matching degree of information related to introduction of the target application 30 but also matching degrees of an author, a signature, a reputation, and the like.

Note that, criterion information does not necessarily need to include introduction criterion information. Specifically, determination of whether to permit execution of the target application 30 may be performed by use of only a criterion other than a criterion relating to introduction of the target application 30, such as a criterion regarding an author of the target application 30.

### Output of Information

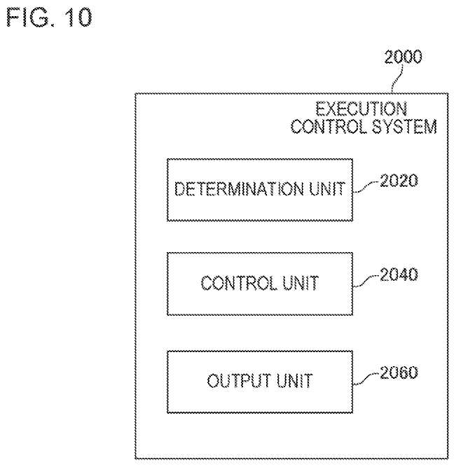

Various kinds of information relating to an operation of the execution control system 2000 may be provided to a user of the target application 30. A functional configuration unit that provides information to a user of the target application 30 in this way is referred to as an output unit, and information output by the output unit is referred to as output information. FIG. 10 is a block diagram illustrating a functional configuration of the execution control system 2000 including an output unit 2060. The output unit 2060 is provided in either or both of the first apparatus 10 and the second apparatus 20.

Output information output by the output unit 2060 is output by any target in which a user of the first apparatus 10 can recognize a content of the output information by the first apparatus 10. For example, the first apparatus 10 displays a screen representing a content of the output information, on a display apparatus connected to the first apparatus 10.

Various contents can be adopted as contents of the output information. For example, output information includes information relating to a final result or a progress of determination by the determination unit 2020. For example, information relating to a final result includes information representing whether execution of the target application 30 is permitted. Information relating to a final result is output, for example, at a timing when determination by the determination unit 2020 is finished.

When execution of the target application 30 is permitted, a message or the like that allows a user to recognize that the target application 30 can be utilized normally is output. For example, the message is such a message as “Execution of the target application 30 is permitted. The target application 30 can be utilized normally.”.

On the other hand, when execution of the target application 30 is not permitted, a message or the like that allows a user to recognize that the target application 30 cannot be utilized normally is output. For example, the message is such a message as “Execution of the target application 30 is not permitted. The target application 30 is finished.”.

As information relating to a progress of determination, for example, a message that allows a user to recognize that determination of whether to permit execution of the target application 30 is performed is output. For example, the information is output at a timing when determination by the determination unit 2020 is started. For example, such a message as “Whether to permit execution of the target application 30 is determined” is output.

When determination by the determination unit 2020 includes a plurality of stages, information relating to a progress of determination is, for example, a message or the like that allows a user to recognize what stage of the determination is performed. For example, it is assumed that second determination is performed because first determination cannot determine whether to permit execution of the target application 30. In this case, such a message as “The first determination is completed. The second determination is started.” or “The second determination is in execution” is output. The messages are output, for example, at a timing when determination shifts to a next stage.

Note that, when the target application 30 is executed in a protected environment, it is preferable to include this intention in output information. For example, such a message as “Whether to permit execution of the target application 30 is determined. The target application 30 is executed in a protected environment.” is output. Moreover, when changing an execution environment of the target application 30 from a protected environment to a normal environment, it is preferable to output a message or the like with which a user can recognize this fact. For example, such a message as “An execution environment of the target application 30 is changed to a normal environment” is output.

### Modification Example

It has been described so far that the execution control system 2000 performs, regarding an application, determination of whether to permit execution of the application and control thereof. However, the execution control system 2000 may perform determination of whether to permit loading of a shared library and control thereof, in addition to or instead of an application. Specifically, the execution control system 2000 performs determination of whether to permit loading of a shared library and control of processing utilizing a shared library, by a method similar to a method of performing determination of whether to permit execution of an application and control of execution of an application. Hereinafter, a shared library targeted for determination and control by the execution control system 2000 is referred to as a target library.

Determination of whether to permit loading of a target library includes first determination and second determination (may include three or more pieces of determinations, as described above), similarly to determination of whether to permit execution of the target application 30. The execution control system 2000 does not perform loading of a target library until the first determination is completed. Then, when the first determination cannot determine whether to permit loading of a target library, and the second determination is performed, the execution control system 2000 loads a shared library in such a way that processing utilizing the target library (execution of a function defined in the shared library, or the like) is performed in a protected environment.

When processing utilizing the target library is executed in a protected environment, the various restrictions described above (a restriction of reading and writing of data, activation of an application, or the like) are applied to the processing. Note that, for a specific achievement method of the restrictions, a method similar to a method of achieving a restriction on the target application 30 can be utilized.

A target library can be similar to the target application 30, in relation to handing according to a result of determination by the execution control system 2000 as well. Specifically, regarding a target library loaded in such a way that processing thereof is executed in a protected environment, when it is determined that the loading is permitted, the control unit 2040 causes processing utilizing the target library to be executed in a normal environment (shifted to a normal environment). Moreover, regarding a target library loaded in such a way that processing thereof is executed in a protected environment, when it is determined that the loading is not permitted, for example, the control unit 2040 performs unloading of the target library.

For a criterion of determination of whether to permit loading of a shared library, a criterion similar to a criterion of determination of whether to permit execution of the target application 30 can be utilized. For example, generally, a shared library is introduced into a terminal by any method (e.g., installed through the Internet), similarly to an application. Thus, regarding a shared library as well, an introduction path thereof can be recognized, similarly to an application. Accordingly, for example, the execution control system 2000 determines whether to permit loading of a target library, by comparing an introduction path of the target library with a criterion relating to introduction of a shared library. For a specific method thereof, a method similar to a method of determining whether to permit execution of the target application 30, based on an introduction path of the target application 30, can be adopted.

While the example embodiments of the present invention have been described above with reference to the drawings, the example embodiments are exemplifications of the present invention, and various configurations other than those described above can also be adopted.

Some or all of the above-described example embodiments can also be described as, but not limited to, the following supplementary notes.

1. An execution control system including:
a determination unit that determines whether to permit an operation of target software;
the determination including first determination and second determination, the second determination performed when the first determination cannot determine whether to permit an operation of the target software; and
a control unit that operates the target software in a protected environment after the first determination is finished and while the second determination is performed.
   2. The execution control system according to supplementary note 1, wherein
determination by the determination unit is started at least either of when an operation of the target software is started, and when the target software is introduced.
   3. The execution control system according to supplementary note 1 or 2, wherein
a time required for the second determination is longer than a time required for the first determination.
   4. The execution control system according to any one of supplementary notes 1 to 3, wherein
writing of data performed by the target software operating in the protected environment is performed for a first storage area that cannot be accessed from another piece of software, and,
when an operation of the target software is permitted, the control unit writes data written in the first storage area, into a second storage area being accessible from at least another piece of software.
   5. The execution control system according to any one of supplementary notes 1 to 4, wherein,
when an operation of the target software is permitted, the control unit changes an operation environment of the target software from the protected environment to a normal execution environment.
   6. The execution control system according to any one of supplementary notes 1 to 5, wherein,
when an operation of the target software is not permitted, the control unit finishes an operation of the target software.
   7. An execution control method executed by a computer, including:
a determination step of determining whether to permit an operation of target software;
the determination including first determination and second determination, the second determination performed when the first determination cannot determine whether to permit an operation of the target software; and
a control step of operating the target software in a protected environment after the first determination is finished and while the second determination is performed.
   8. The execution control method according to supplementary note 7, further including
starting determination by the determination step at least either of when an operation of the target software is started, and when the target software is introduced.
   9. The execution control method according to supplementary note 7 or 8, wherein
a time required for the second determination is longer than a time required for the first determination.
   10. The execution control method according to any one of supplementary notes 7 to 9, further including:
performing writing of data performed by the target software operating in the protected environment, for a first storage area that cannot be accessed from another piece of software; and,
when an operation of the target software is permitted, in the control step, writing data written in the first storage area, into a second storage area being accessible from at least another piece of software.
   11. The execution control method according to any one of supplementary notes 7 to 10, further including,
when an operation of the target software is permitted, in the control step, changing an operation environment of the target software from the protected environment to a normal execution environment.
   12. The execution control method according to any one of supplementary notes 7 to 11, further including,
when an operation of the target software is not permitted, in the control step, finishing an operation of the target software.
   13. A program causing a computer to execute each step of the execution control method according to any one of supplementary notes 7 to 12.

What is claimed is:

1. An execution control system comprising:
a memory storing instructions; and
a processor configured to execute the instructions to perform operations, the operations comprising:
performing determination whether to permit an operation of target software, the determination including first determination and second determination, the second determination performed when the first determination cannot determine whether to permit an operation of the target software; and
operating the target software in a protected environment after the first determination is finished and while the second determination is performed.

2. The execution control system according to claim 1, wherein
the determination is started at least either of when an operation of the target software is started, and when the target software is introduced.

3. The execution control system according to claim 1, wherein
a time required for the second determination is longer than a time required for the first determination.

4. The execution control system according to claim 1, wherein the operations further comprise:
writing data performed by the target software operating in the protected environment into a first storage area that cannot be accessed from another piece of software; and,
when an operation of the target software is permitted, writing data written in the first storage area, into a second storage area being accessible from at least another piece of software.

5. The execution control system according to claim 1, wherein the operations further comprise,
when an operation of the target software is permitted, the control unit changes changing an operation environment of the target software from the protected environment to a normal execution environment.

6. The execution control system according to claim 1, wherein the operations further comprise,
when an operation of the target software is not permitted, finishing an operation of the target software.

7. An execution control method executed by a computer, comprising:
performing determination whether to permit an operation of target software, the determination including first determination and second determination, the second determination performed when the first determination cannot determine whether to permit an operation of the target software; and
operating the target software in a protected environment after the first determination is finished and while the second determination is performed.

8. The execution control method according to claim 7, further comprising
starting the determination at least either of when an operation of the target software is started, and when the target software is introduced.

9. The execution control method according to claim 7, wherein
a time required for the second determination is longer than a time required for the first determination.

10. The execution control method according to claim 7, further comprising:
performing writing of data performed by the target software operating in the protected environment, for a first storage area that cannot be accessed from another piece of software; and,
when an operation of the target software is permitted, writing data written in the first storage area, into a second storage area being accessible from at least another piece of software.

11. The execution control method according to claim 7, further comprising,
when an operation of the target software is permitted, changing an operation environment of the target software from the protected environment to a normal execution environment.

12. The execution control method according to claim 7, further comprising,
when an operation of the target software is not permitted, finishing an operation of the target software.

13. A non-transitory computer readable medium storing a program causing a computer to execute an execution control method, the method comprising:
performing determination whether to permit an operation of target software, the determination including first determination and second determination, the second determination performed when the first determination cannot determine whether to permit an operation of the target software; and
operating the target software in a protected environment after the first determination is finished and while the second determination is performed.
